(19) United States
(12) Patent Application Publication
(10) Pub. No.: US 2025/0340391 A1
(43) Pub. Date: Nov. 6, 2025

(54) AUTOMATED CARGO UNLOADING METHOD AND COMPUTING DEVICE FOR PERFORMING THE SAME

(71) Applicant: STC ENG CO.,LTD., Pyeongtaek-si Gyeonggi-do (KR)

(72) Inventors: Byung Jin JUNG, Hwaseong-si Gyeonggi-do (KR); Jong Sam PARK, Hwaseong-si Gyeonggi-do (KR); Byung Taek JUNG, Osan-si Gyeonggi-do (KR)

(21) Appl. No.: 19/267,278

(22) Filed: Jul. 11, 2025

Related U.S. Application Data
(63) Continuation of application No. PCT/KR2023/006953, filed on May 22, 2023.

(51) Int. Cl. B65G 67/24; B25J 9/00; B25J 9/16; B25J 11/00; B65G 61/00

(52) U.S. Cl. CPC B65G 67/24; B25J 9/0093; B25J 9/1682; B25J 11/008; B65G 61/00

(57) ABSTRACT

An automated cargo unloading method and a computing device for performing the same. The method according to an embodiment is performed by an automated cargo unloading machine including one or more processors and a memory for storing one or more programs executed by the one or more processors, and the method includes obtaining a loaded cargo image photographed inside a cargo box in which cargo is loaded, recognizing each of the loaded cargo in the loaded cargo image based on edge information and depth information of each object, generating loaded cargo-related information including one or more of a position, a size, a type, and a loaded pattern of the cargo inside the cargo box of each of the recognized cargo, and determining one or more of an unloading order of the cargo inside the cargo box and an unloading mode of the cargo based on the loaded cargo-related information.

### STATEMENT REGARDING GOVERNMENT SPONSORED RESEARCH OR DEVELOPMENT

The present invention was derived from a research conducted as a part of the Ministry of Trade, Industry and Energy's Robot Industry Core Technology Development Project-Cross-Departmental Cooperation Robot Product Technology (Project Identification No.: 1415168943, Sub-Project No.: 20009109, Research Project Title: Development of a Robot-Utilized Trunk Line Cargo Logistics Transport Vehicle Unloading System, Institute of Organization: STC Engineering Co., Ltd., Research Period: May 1, 2020 to Dec. 31, 2024).

Meanwhile, in all the aspects of the inventive concept, there is no property interest in the government of the Republic of Korea.

### BACKGROUND OF THE DISCLOSURE

### 1. Field of the Disclosure

Embodiments of the present invention relates to an automated cargo unloading technology.

### 2. Description of the Related Art

Over the past three years, a volume of parcel delivery has increased by 10 to 13% annually, but an average delivery cost of parcel has decreased by 2 to 3% annually, and thus automation in a logistics industry is becoming very important to maintain the competitiveness of companies. Currently, automation in logistics center using equipment such as belt sorters is applied to a significant portion of a parcel delivery process, but an unloading operation of unloading various parcel cargo from a vehicle's cargo box is still dependent on manual work.

In addition, in order to handle a nationwide daily parcel delivery demand, trunk line cargo trucks at hub terminals are usually loaded with about 2,000 cargo per truck, and two workers have to unload all of the cargo within one hour. This is the most intense work among various operations at parcel hub terminals and it is being avoided by workers. Therefore, it is required to develop a robotic system capable of automating the unloading operation of the trunk line cargo trucks.

### SUMMARY OF THE DISCLOSURE

An automated cargo unloading method according to an embodiment of the present invention is performed by an automated cargo unloading machine including one or more processors and a memory for storing one or more programs executed by the one or more processors, and the method includes obtaining a loaded cargo image photographed inside a cargo box in which cargo is loaded, recognizing each of the loaded cargo in the loaded cargo image based on edge information and depth information of each object, generating loaded cargo-related information including one or more of a position, a size, a type, and a loaded pattern of the cargo inside the cargo box of each of the recognized cargo, and determining one or more of an unloading order of the cargo inside the cargo box and an unloading mode of the cargo based on the loaded cargo-related information.

The automated cargo unloading method may further include confirming whether a caution label is attached to the cargo through the loaded cargo image, and confirming a type of cautions by analyzing the caution label when the caution label is attached.

The automated cargo unloading method may further include assigning a cargo caution classification index to the corresponding cargo according to the type of the cautions, and unloading the corresponding cargo from the cargo box based on the cargo caution classification index.

The automated cargo unloading machine may be equipped with a pair of robotic arm devices including an arm unit provided to enable multiaxial rotation and forward and backward movement and a hand unit connected to the arm unit and contacting the cargo to unload the cargo, respectively, and each of the hand units may include an unloading conveyor belt provided to sweep down the cargo inside the cargo box.

The determining of the one or more of the unloading order of the cargo and the unloading mode of the cargo may include confirming whether a surrounding space of the cargo positioned at an uppermost portion of the cargo box is more empty than a preset space, and determining the unloading mode of the cargo positioned at the uppermost portion to be a down sweep mode in a case where an upper portion of the cargo is more empty than the preset space based on the cargo positioned at the uppermost portion.

The down sweep mode may rotate the unloading conveyor belt toward the automated cargo unloading machine to sweep the cargo downward in a state in which the unloading conveyor belt is disposed to face the cargo at the upper portion of the cargo.

The determining of the one or more of the unloading order the cargo and the unloading mode of the cargo may include confirming whether a surrounding space of the cargo positioned at an uppermost portion of the cargo box is more empty than a preset space, and determining the unloading mode of the cargo positioned at the uppermost portion to be a side sweep mode in a case where both side portions are more empty than the preset space based on the cargo positioned at the uppermost portion.

The side sweep mode may rotate a pair of the unloading conveyor belts toward the automated cargo unloading machine to sweep the cargo downward in a state in which the loaded cargo is positioned between the pair of unloading conveyor belts and the pair of unloading conveyor belts are disposed to face the cargo at both side portions of the cargo.

Each of the hand units may further include a suction part for sucking the cargo inside the cargo box, and the determining of the one or more of the unloading order of the cargo and the unloading mode of the cargo may include confirming whether a surrounding space of the cargo positioned at an uppermost portion of the cargo box is more empty than a preset space, and determining the unloading mode of the cargo to be a suction mode according to the type of the cargo positioned at the uppermost portion in a case where the surrounding space is not more empty than the preset space.

Each of the hand units may further include a clamp part capable of picking up the cargo inside the cargo box, and the determining of the one or more of the unloading order of the cargo and the unloading mode of the cargo may include confirming whether a surrounding space of the cargo positioned at an uppermost portion of the cargo box is more empty than a preset space, and determining the unloading mode of the cargo to be a clamping mode according to the type of the cargo positioned at the uppermost portion in a case where the surrounding space is not more empty than the preset space.

A computing device according to an embodiment disclosed herein includes one or more processors, a memory, and one or more programs, wherein the one or more programs are stored in the memory and configured to be executed by the one or more processors, and the one or more programs include a command for obtaining a loaded cargo image photographed inside a cargo box in which the cargo is loaded, a command for recognizing each of the loaded cargo in the loaded cargo image based on edge information and depth information of each object, a command for generating loaded cargo-related information including one or more of a position, a size, a type, and a loaded pattern of the cargo inside the cargo box of each of the recognized cargo, and a command for determining the one or more of an unloading order of the cargo inside the cargo box and an unloading mode of the cargo based on the loaded cargo-related information.

### BRIEF DESCRIPTION OF THE DRAWINGS

FIGS. 1 and 2 are a front perspective view and a rear perspective view showing an automated cargo unloading machine according to an embodiment of the present invention.

FIG. 3 is a view showing a state in which an automated cargo unloading machine according to an embodiment of the present invention enters a cargo box and unloads cargo.

FIG. 4 is a perspective view showing a robotic arm device according to an embodiment of the present invention.

FIG. 5 is a view showing each of axis parts in an arm unit of a robotic arm device according to an embodiment of the present invention.

FIGS. 6 and 7 are perspective views showing one side portion and the other side portion of a hand unit according to an embodiment of the present invention.

FIGS. 8A and 8B are views showing a state in which a suction pad portion is moved forward in an embodiment of the present invention.

FIGS. 9A and 9B are views showing a state in which a clamping portion is moved forward in an embodiment of the present invention.

FIGS. 10, 11, 12, 13, 14A, 14B, 14C, 15A, 15B, 15C, 16A, 16B and 16C are views showing an operation of an automated cargo unloading machine unloading cargo from a cargo box according to an embodiment of the present invention.

FIG. 17 is a view showing a process of determining an unloading mode in an automated cargo unloading method according to an embodiment of the present invention.

FIG. 18 is a view showing a state in which a caution label is attached to cargo in an embodiment of the present invention.

FIG. 19 is a flow chart showing a method of unloading cargo using an automated cargo unloading machine according to an embodiment of the present invention.

FIG. 20 is a view showing a state in which an unloading order of cargo and an unloading mode of the cargo are determined according to loaded cargo-related information according to an embodiment of the present invention.

FIG. 21 is a block diagram showing a computing environment including a computing device suitable for using in exemplary embodiments.

### DETAILED DESCRIPTION OF EXEMPLARY EMBODIMENTS

Hereinafter, embodiments of the present invention will be described in more detail with reference to the attached drawings. The embodiments of the present invention may be modified in various forms, and the scope of the present invention should not be construed as being limited to the embodiments below. The embodiments are provided to explain the present invention more completely to those having ordinary skill in the art. Therefore, elements in the drawings are exaggerated to emphasize a clearer description.

In order to make clear the solution of the problem which the present invention seeks to solve, a configuration of the present invention will be described in detail with reference to the attached drawings in accordance with a preferred embodiment of the invention, but in assigning reference numerals to the components of the drawings, it is hereby disclosed in advance that the same components have been assigned the same reference numerals, even though they are on different drawings, and that in the description of the drawings, components of other drawings may be cited where necessary.

Meanwhile, directional terms such as upper side, lower side, one side, other side, etc. are used in relation to the orientation of the disclosed drawings. Since components of embodiments of the present invention may be positioned in a variety of orientations, the directional terms are used for illustrative purposes only and are not limiting.

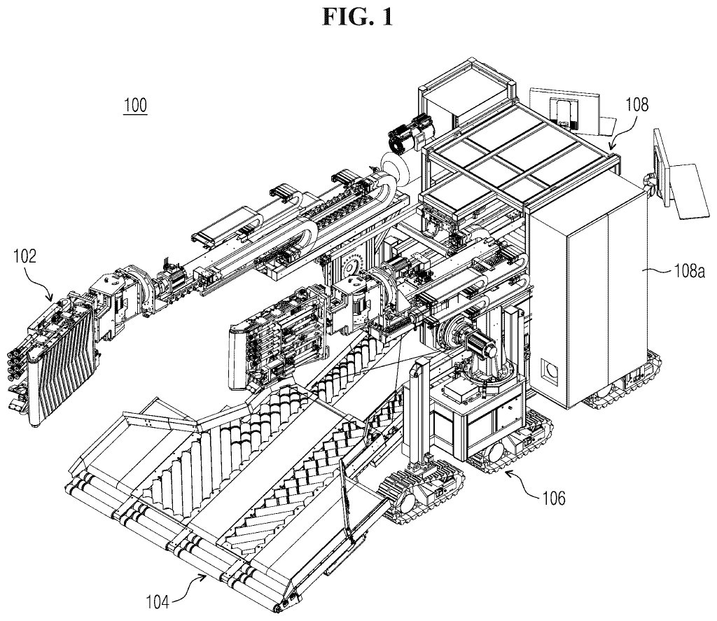

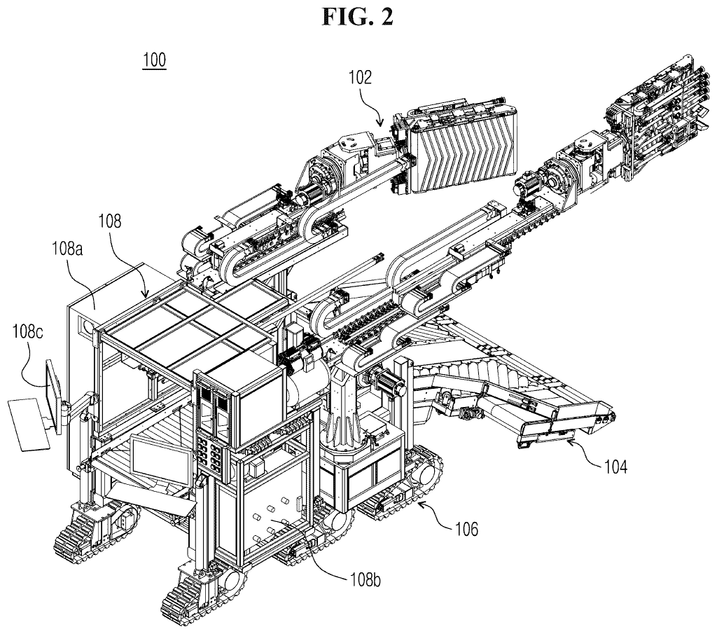

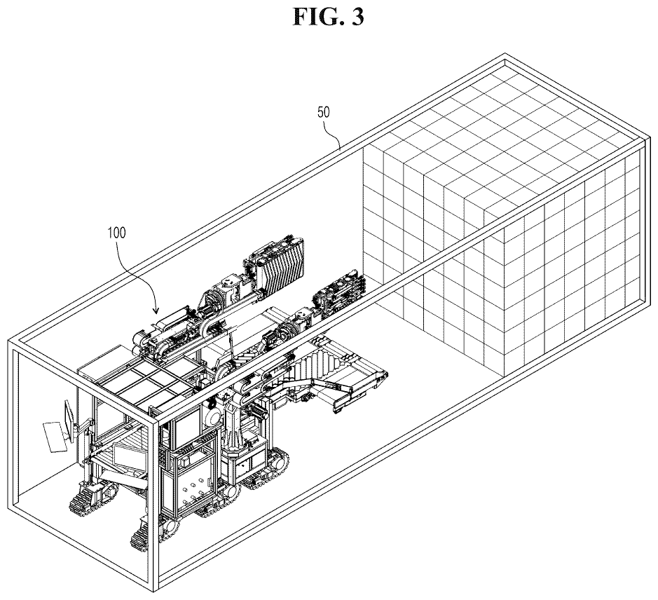

FIGS. 1 and 2 are a front perspective view and a rear perspective view showing an automated cargo unloading machine according to an embodiment of the present invention, and FIG. 3 is a view showing a state in which an automated cargo unloading machine enters a cargo box and unloads cargo according to an embodiment of the present invention.

FIG. 1 is a front perspective view showing an automated cargo unloading machine according to an embodiment of the present invention, and FIG. 2 is a rear perspective view showing an automated cargo unloading machine according to an embodiment of the present invention.

Referring to FIGS. 1 to 3, an automated cargo unloading machine 100 may include a robotic arm device 102, a conveyor device 104, a track device 106, and a main body frame 108. The automated cargo unloading machine 100 is for unloading or transporting cargo (hereinafter referred to as loaded cargo) loaded inside a cargo box 50. Here, the cargo box 50 may be a cargo box or a container mounted on a cargo vehicle (e.g., a trunk line cargo vehicle, etc.). The automated cargo unloading machine 100 may unload the cargo loaded inside the cargo box at an entrance of the cargo box 50 or as shown in FIG. 3, may enter the inside of the cargo box 50 to unload the cargo loaded inside the cargo box.

In addition, the automated cargo unloading machine 100 may include various sensor equipment (e.g., vision sensor, Lidar, or vision and Lidar fusion sensor, scanner, etc.) for recognizing a loaded pattern of the cargo, a loaded position of the cargo, a type of the cargo, etc. and determining an unloading mode of the cargo according thereto.

The robotic arm device 102 may be provided on both sides of the main body frame 108. That is, the robotic arm device 102 may be provided as a pair on both sides of the main body frame 108. The robotic arm device 102 may be provided to unload various types of the cargo such as boxes, plastic pouches, and sacks that are loaded in bulk inside the cargo box by operating as a pair like human arms. The robotic arm device 102 may unload the cargo loaded inside the cargo box toward the conveyor device 104.

The conveyor device 104 may be mounted on the main body frame 108. The conveyor device 104 may be provided along a longitudinal direction of the robotic arm device 102 on the main body frame 108. The conveyor device 104 may serve to transport the loaded cargo unloaded by the robotic arm device 102 to a rear of the main body frame 108.

The conveyor device 104 may operate in engagement with the robotic arm device 102. A front end portion of the conveyor device 104 may be provided to adjust a height thereof according to the operation of the robotic arm device 102. In this case, the front end portion of the conveyor device 104 may be height-adjusted according to a height of the loaded cargo to be unloaded by the robotic arm device 102.

The track device 106 may be provided under the main body frame 108. The track device 106 may serve to move the automated cargo unloading machine 100. That is, the track device 106 may move the automated cargo unloading machine 100 to the entrance of the cargo box or may allow it to enter the inside of the cargo box.

The main body frame 108 may serve to support the automated cargo unloading machine 100. The main body frame 108 may be provided in various forms capable of supporting the automated cargo unloading machine 100, but the forms are not limited thereto. The main body frame 108 may be provided to support the robotic arm device 102. The main body frame 108 may be provided to support the conveyor device 104. In addition, the main body frame 108 may be connected to the track device 106 at an upper portion of the track device 106.

An electronic control box 108a including circuit devices that provide power to the automated cargo unloading machine 100 and control an operation of the automated cargo unloading machine 100 may be mounted on the main body frame 108. In addition, a hydraulic pressure tank 108b for providing hydraulic pressure to one or more of the robotic arm device 102 and the track device 106 may be mounted on the main body frame 108. In addition, one or more monitors 108c for confirming the operation of the automated cargo unloading machine 100 may be mounted on the main body frame 108.

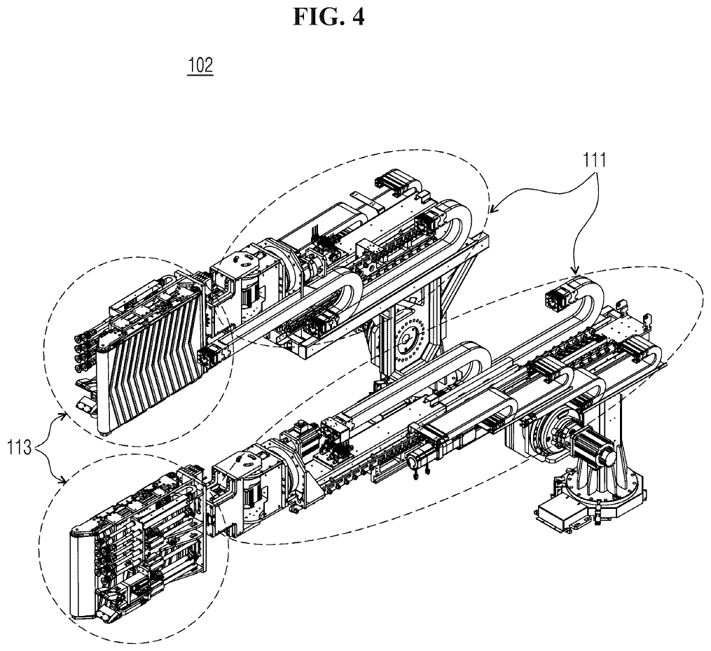

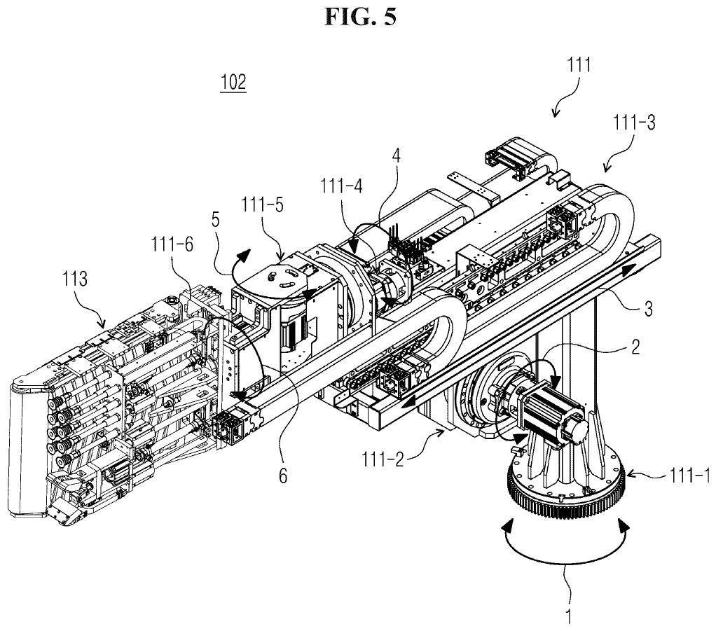

FIG. 4 is a perspective view showing a robotic arm device 102 according to an embodiment of the present invention, and FIG. 5 is a view showing each of axis parts in an arm unit of a robotic arm device 102 according to an embodiment of the present invention.

Referring to FIGS. 4 and 5, the robotic arm device 102 may include an arm unit 111 and a hand unit 113.

The robotic arm device 102 may operate in the unloading mode determined according to one or more of the loaded pattern of the cargo inside the cargo box, the loaded position of the cargo, and the type of the cargo. The unloading mode is an operation mode for unloading the cargo inside the cargo box, for example, the unloading mode may be a down sweep mode, a side sweep mode, a suction mode, and a clamping mode, etc.

The arm unit 111 may be mounted on both sides of the main body frame 108. The arm unit 111 may be provided to be enable multiaxial rotation. In addition, the arm unit 111 may be provided to enable forward and backward movement. The arm unit 111 may be provided to perform the multiaxial rotation and the forward or backward movement simultaneously. In an exemplary embodiment, the arm unit 111 may be provided to have a 6-axis degree of freedom (DoF). The arm unit 111 may include a first axis part 111-1, a second axis part 111-2, a third axis part 111-3, a fourth axis part 111-4, a fifth axis part 111-5, and a sixth axis part 111-6.

The first axis part 111-1 may be mounted on the main body frame 108. The first axis part 111-1 may be provided to enable rotation in a first direction (1). The second axis part 111-2 may be provided in connection with the first axis part 111-1. The second axis part 111-2 may be provided to enable rotation in a second direction (2). The third axis part 111-3 may be provided in connection with the second axis part 111-2. The third axis part 111-3 may be provided to enable forward and backward movement along a third direction (3).

The fourth axis part 111-4 may be provided in connection with the third axis part 111-3. The fourth axis part 111-4 may be provided to enable rotation in a fourth direction (4). The fifth axis part 111-5 may be provided in connection with the fourth axis part 111-4. The fifth axis part 111-5 may be provided to enable rotation in a fifth direction (5). The sixth axis part 111-6 may be provided in connection with the fifth axis part 111-5. The sixth axis part 111-6 may be provided to enable rotation in a sixth direction (6). Here, the first direction (1) to the sixth direction 6 may be different directions from each other, respectively. In this case, the arm unit 111 may enable forward and backward movement while rotating in five axis directions.

The hand unit 113 may be provided in connection with an end portion of the arm unit 111. The hand unit 113 is a part that contacts the loaded cargo and unloads the loaded cargo toward the conveyor device 104. The hand unit 113 may be provided in connection with the sixth axis part 111-6. Since the hand unit 113 is connected to the arm unit 111, the hand unit 113 may move forward and backward while rotating in the five axis directions together with the arm unit 111 according to an operation of the arm unit 111. As such, the robotic arm device 102 is provided to have the 6-axis Dof, and thus it is possible to unload the loaded cargo by covering an entire range in the cargo box.

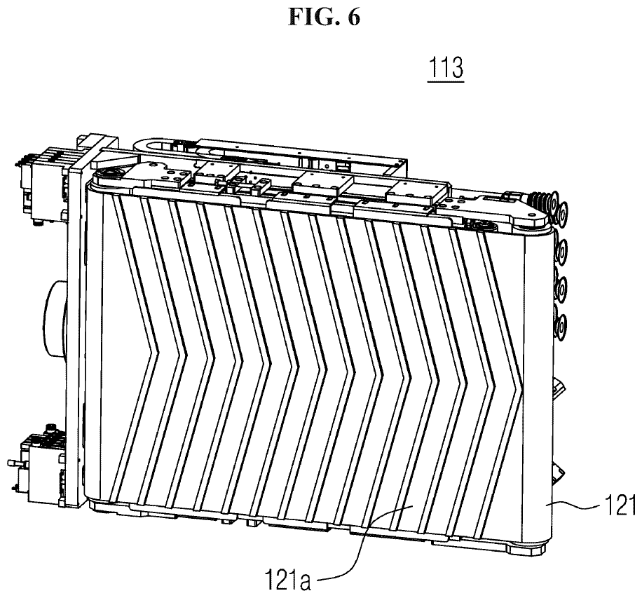

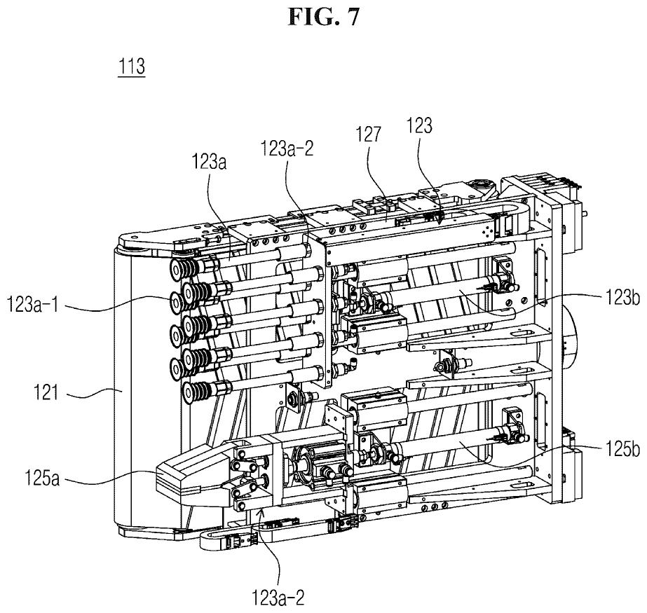

FIGS. 6 and 7 are perspective views showing one side portion and the other side portion of a hand unit 113 according to an embodiment of the present invention.

FIG. 6 is a view showing one side portion of a hand unit 113 according to an embodiment of the present invention, and FIG. 7 is a view showing the other side portion of a hand unit 113 according to an embodiment of the present invention.

Referring to FIGS. 6 and 7, the hand unit 113 may include a conveyor belt 121, a suction part 123, and a clamp part 125.

The unloading conveyor belt 121 may be mounted on the one side portion of the hand unit 113. When the robotic arm device 102 is compared to a human arm, the one side portion of the hand unit 113 may be compared to a palm. The unloading conveyor belt 121 may be provided along a longitudinal direction of the arm unit 111. The unloading conveyor belt 121 may be provided to rotate in a certain direction. For example, the unloading conveyor belt 121 may be provided in a loop shape to rotate circularly.

The unloading conveyor belt 121 may be provided to rotate in a direction of the main body frame 108 (i.e., in an inward direction). That is, in the pair of robotic arm devices 102, the unloading conveyor belt 121 of each of the hand units 113 may be provided to rotate in the direction of the main body frame 108.

As the pair of unloading conveyor belts 121 rotate in the direction of the main body frame 108, the loaded cargo in contact with the pair of unloading conveyor belts 121 between the pair of unloading conveyor belts 121 are swept in the direction of the main body frame 108 and unloaded toward the conveyor device 104. That is, the unloading conveyor belt 121 is used in a sweep mode and may be used when the unloading mode of the robotic arm device 102 is the down sweep mode or the side sweep mode.

An uneven pattern part 121a may be formed on a surface of the unloading conveyor belt 121 to increase friction with the loaded cargo when sweeping down the loaded cargo. The uneven pattern part 121a may be provided in a form that protrudes from the surface of the unloading conveyor belt 121, but it is not limited thereto. The uneven pattern part 121a may be provided in plural at regular intervals along a longitudinal direction of the unloading conveyor belt 121.

The suction part 123 and the clamp part 125 may be provided on the other side portion of the hand unit 113, respectively. When the robotic arm device 102 is compared to a human arm, the other side portion of the hand unit 113 may be compared to a back of a hand. In the other side portion of the hand unit 113, the suction part 123 and the clamp part 125 may be disposed at top and bottom, respectively. The suction part 123 and the clamp part 125 may be provided along a longitudinal direction of the hand unit 113, respectively.

In an exemplary embodiment, the suction part 123 and the clamp part 125 may be mounted on the hand unit 113 through a hand bracket 127. Both sides of the hand bracket 127 may be fixed to both sides of the unloading conveyor belt 121. The hand bracket 127 may be provided between the unloading conveyor belt 121, and the suction part 123 and the clamp part 125.

The suction part 123 may serve to suck and unload the loaded cargo inside the cargo box. That is, the suction part 123 may be used when the unloading mode of the robotic arm device 102 is the suction mode. For example, the suction part 123 may be provided to enable forward and backward movement along the longitudinal direction of the hand unit 113. The suction part 123 may include a suction pad portion 123a and a suction driving portion 123b.

The suction pad portion 123a is a part that sucks the loaded cargo. The suction pad portion 123a may be provided in plural. An end of each of the plurality of suction pad portions 123a may be fixed to a mounting plate 123a-2. The mounting plate 123a-2 may be connected to the suction driving portion 123b. Here, it is shown that the plurality of suction pad portions 123a are provided, but it is not limited thereto.

A suction cup 123a-1 may be provided at an end portion of the suction pad portion 123a to vacuum-suck the loaded cargo. The suction cup 123a-1 may be provided in a bellows shape to be able to bend in various directions, but the shape is not limited thereto.

The suction driving portion 123b may be provided to move the suction pad portion 123a forward and backward. In addition, the suction driving portion 123b may include a vacuum generator so that the suction pad portion 123a sucks the loaded cargo.

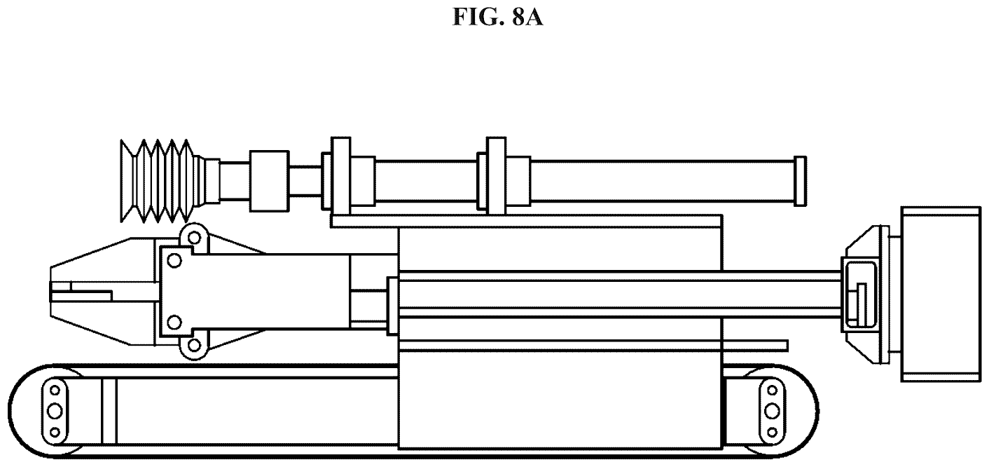

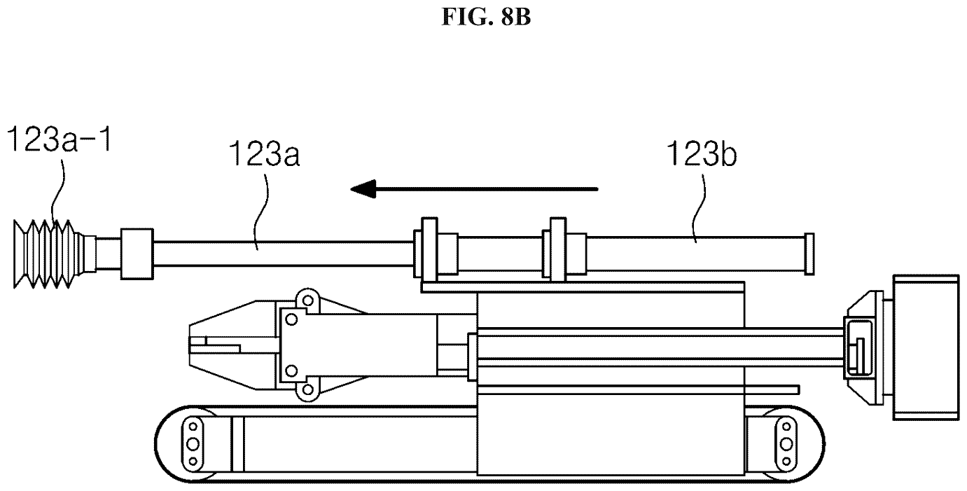

FIG. 8 is a view showing a state in which a suction pad portion 123a is moved forward in an embodiment of the present invention.

FIG. 8A is a view showing a state before the suction pad portion 123a is moved forward in an embodiment of the present invention, and FIG. 8B is a view showing a state after the suction pad portion 123a is moved forward in an embodiment of the present invention.

Referring to FIGS. 8A and 8B, the suction driving portion 123b may move the suction pad portion 123a forward to suck the loaded cargo in the suction mode. The suction driving portion 123b may move the suction pad portion 123a backward to an original position thereof after unloading the sucked loaded cargo.

Here, it is described that the suction pad portion 123a moves forward to suck the loaded cargo, but it is not limited thereto, and the hand unit 111 may also suck the loaded cargo through the suction pad portion 123a after moving toward the loaded cargo in a state in which the suction pad portion 123a is fixed.

The clamp part 125 may serve to pick up to unload the loaded cargo inside the cargo box. That is, the clamp part 125 may be used when the unloading mode of the robotic arm device 102 is the clamping mode. For example, the clamp part 125 may be provided to be enable forward and backward movement along the longitudinal direction of the hand unit 113. The clamp part 125 may include a clamping portion 125a and a clamp driving portion 125b.

The clamping portion 125a is a part that picks up the loaded cargo. In this case, the type of the loaded cargo may be a burlap sack. That is, the clamping portion 125a may be provided to pick up the burlap sack from the loaded cargo. To this end, an end portion of the clamping portion 125a may be provided in a clamp shape. The clamp driving portion 125b may be provided to move the clamping portion 125a forward and backward.

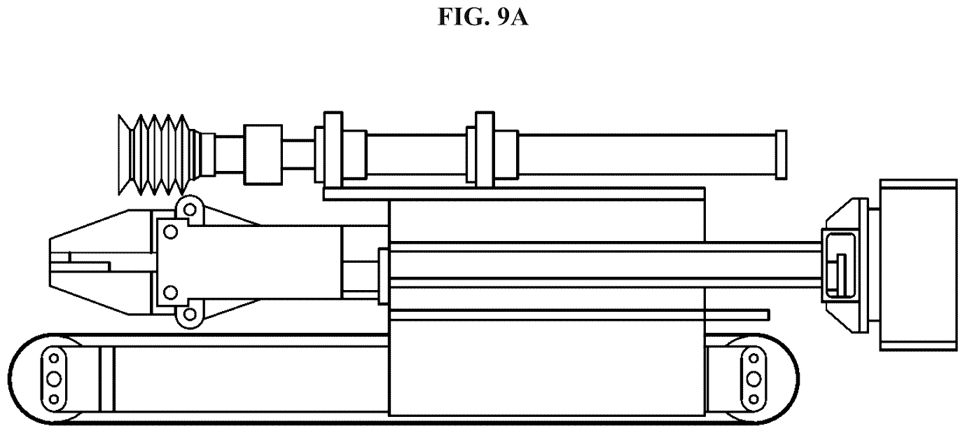

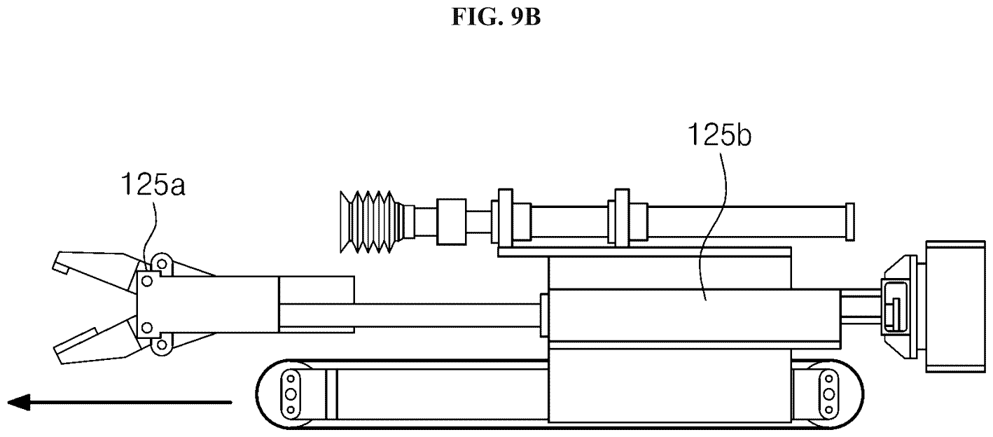

FIG. 9 is a view showing a state in which a clamping portion 125a is moved forward in an embodiment of the present invention.

FIG. 9A is a view showing a state before the clamping portion 125a is moved forward in an embodiment of the present invention, and FIG. 9B is a view showing a state after the clamping portion 125a is moved forward in an embodiment of the present invention.

Referring to FIGS. 9A and 9B, the clamp driving portion 125b may move the clamping portion 125a forward to pick up the loaded cargo in the clamping mode. The clamp driving portion 125b may move the clamping portion 125a backward to an original position thereof after unloading the loaded cargo.

Here, it is described that the clamping portion 125a moves forward to pick up the loaded cargo, but it is not limited thereto, and the hand unit 111 may also be provided to clamp the loaded cargo through the clamping portion 125a after moving toward the loaded cargo in a state in which the clamping portion 125a is fixed.

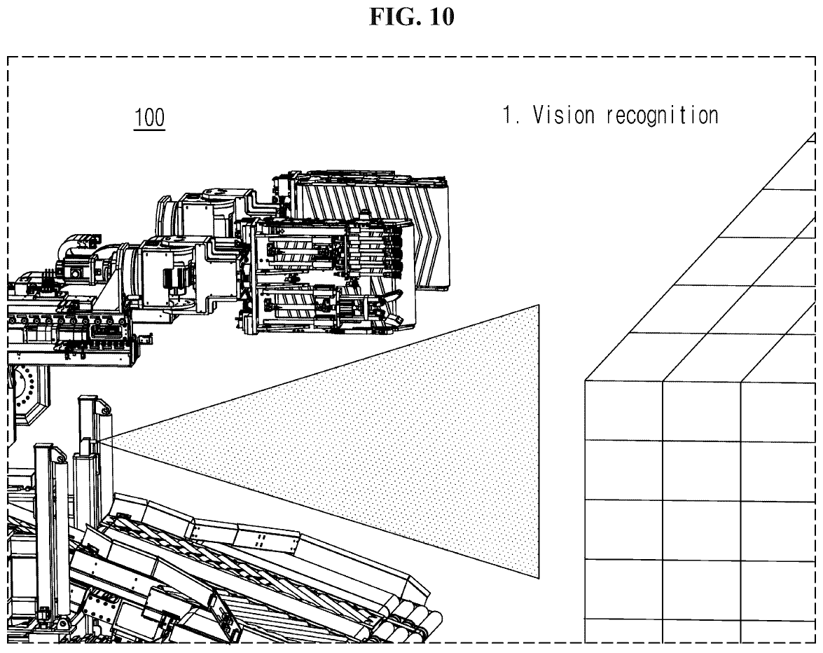

FIGS. 10 to 16 are views showing an operation of an automated cargo unloading machine unloading cargo from a cargo box according to an embodiment of the present invention.

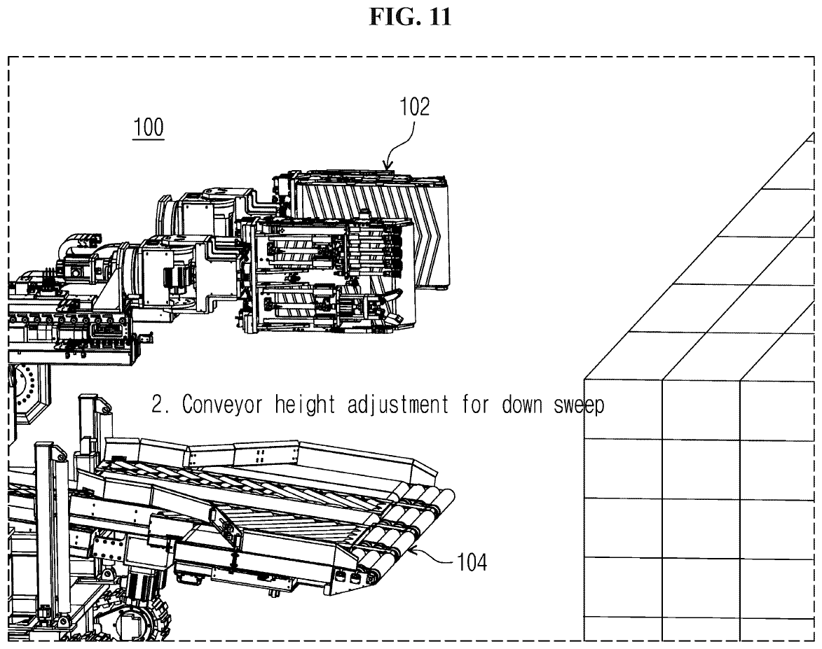

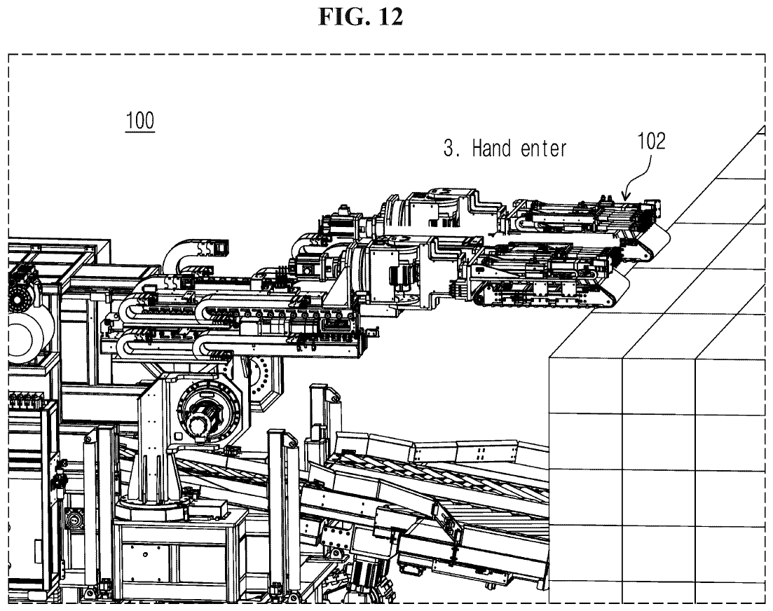

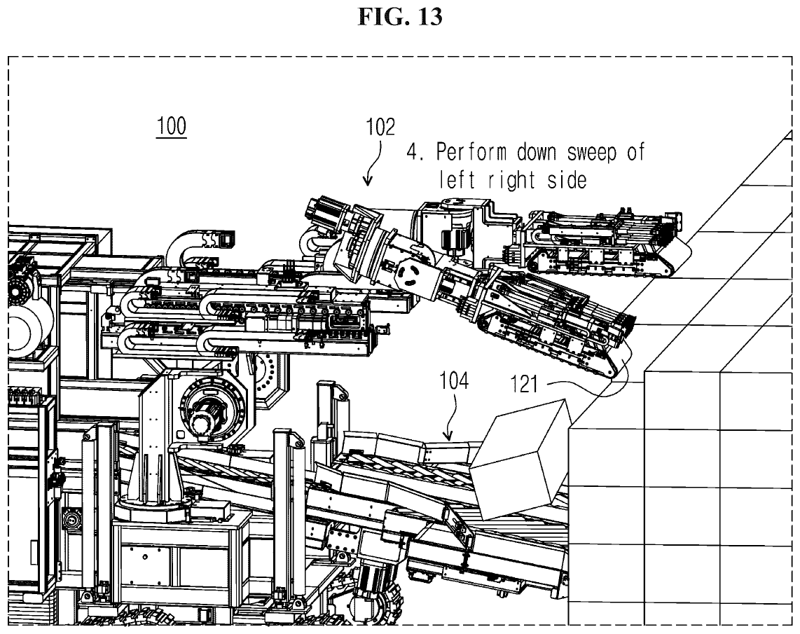

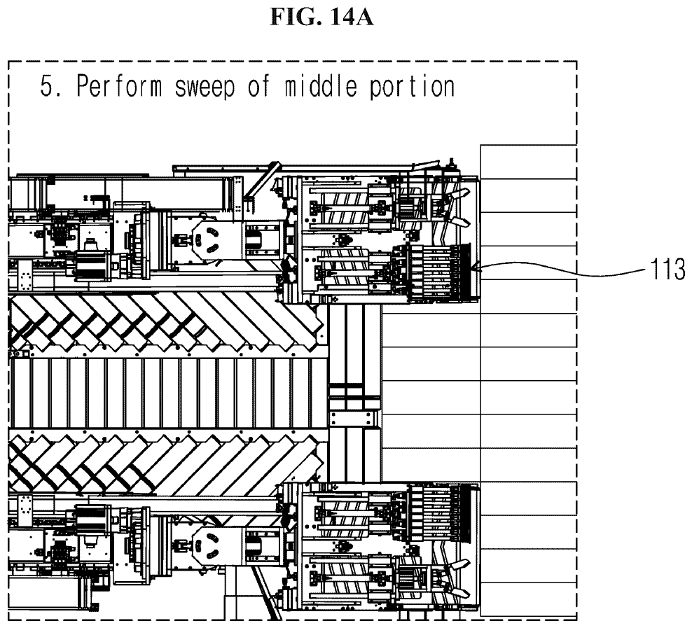

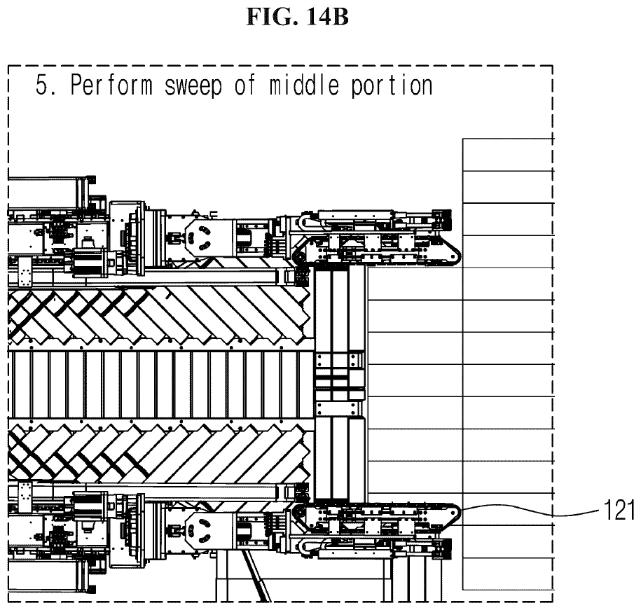

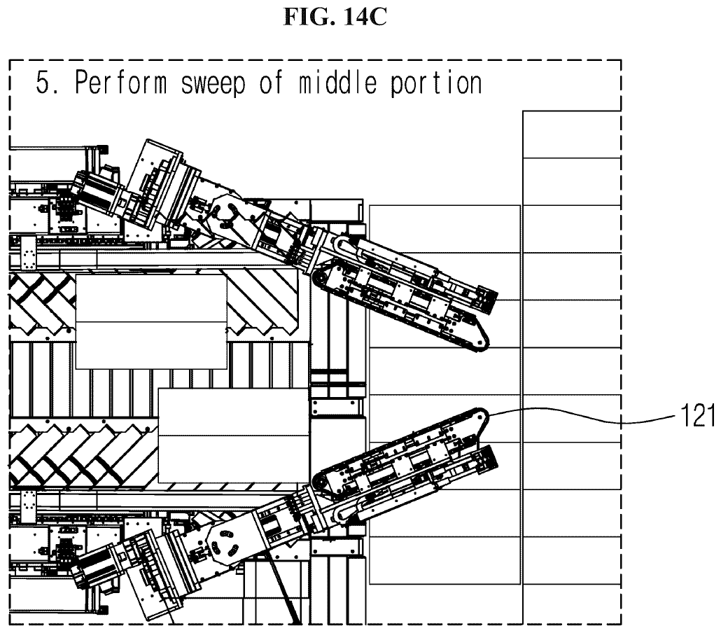

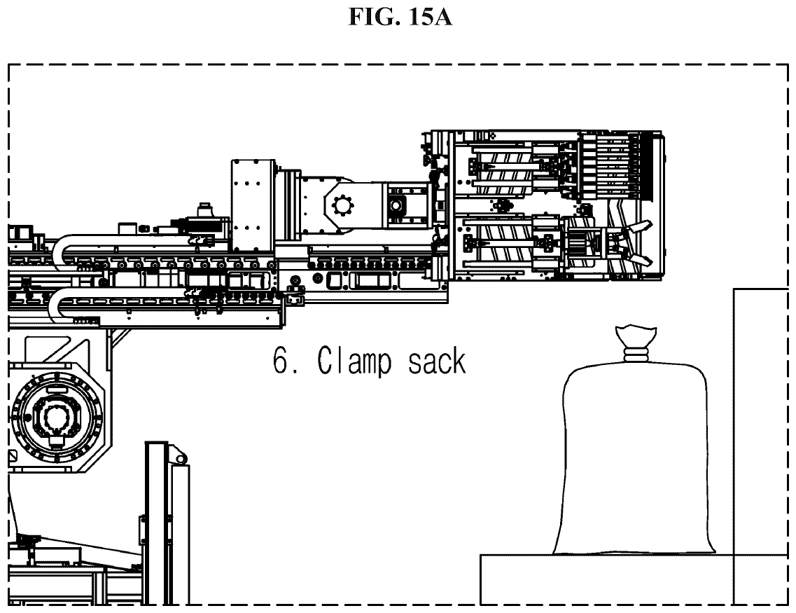

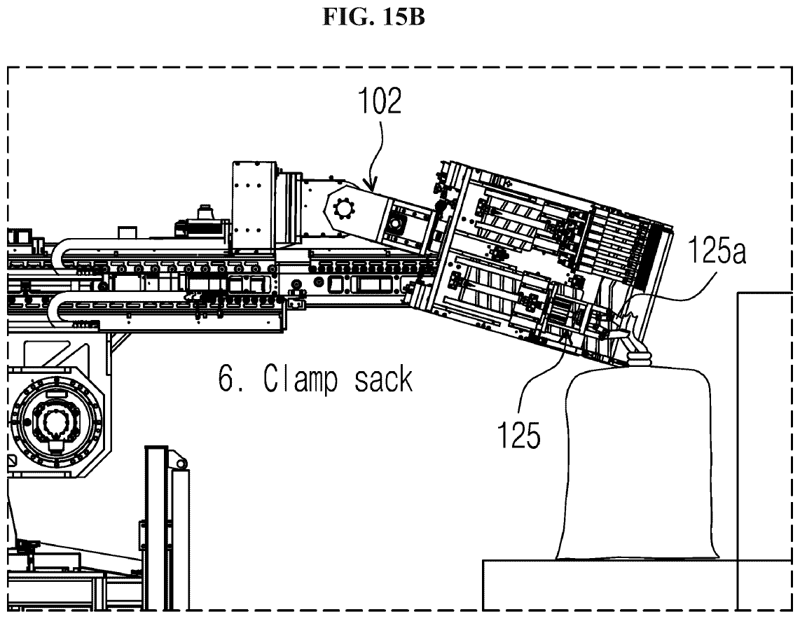

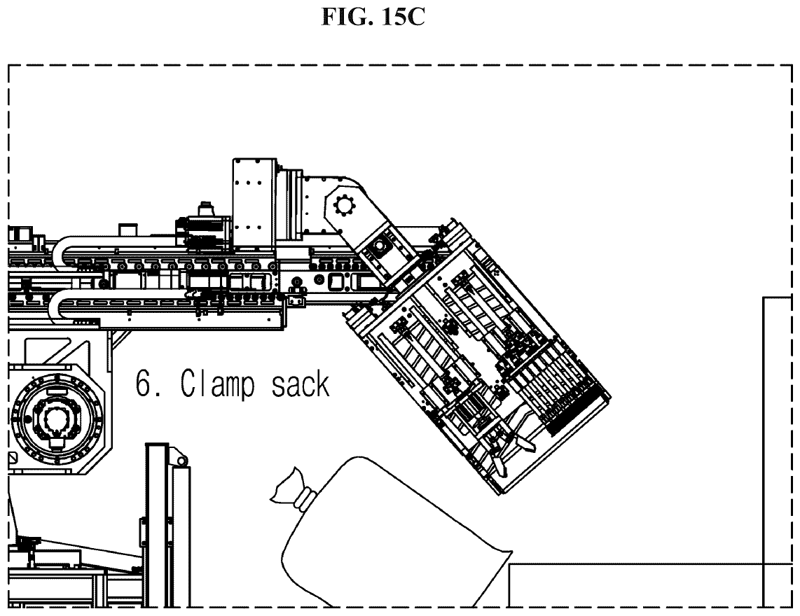

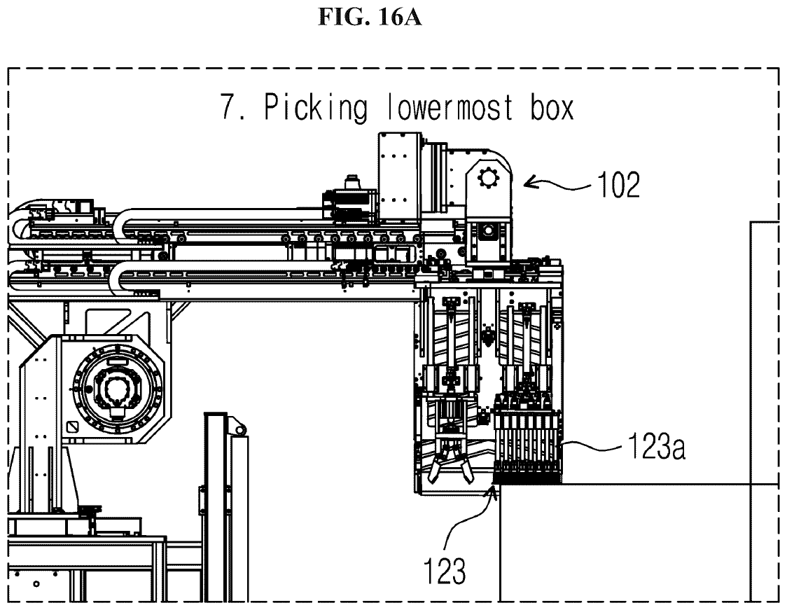

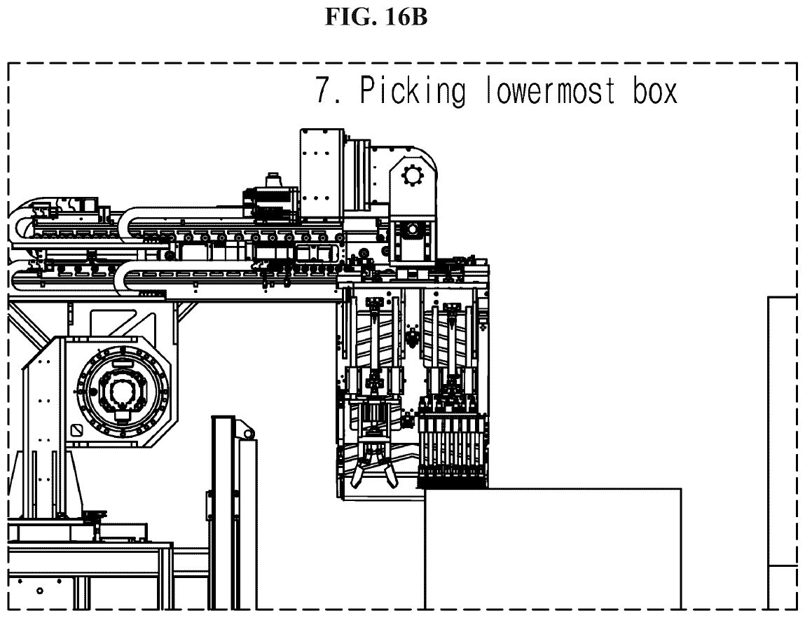

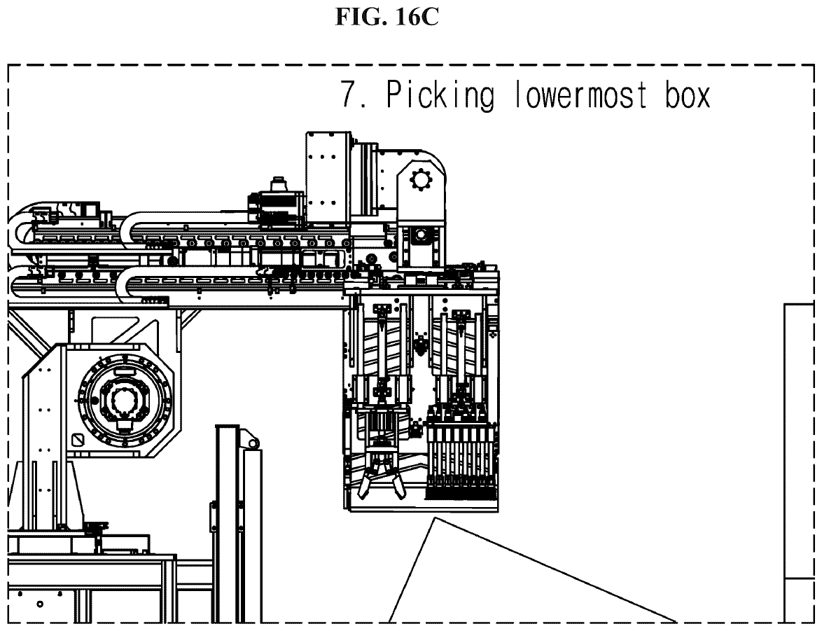

FIG. 10 is a view showing a recognition operation of an automated cargo unloading machine according to an embodiment of the present invention, FIG. 11 is a view showing a height adjustment operation of an automated cargo unloading machine according to an embodiment of the present invention, FIG. 12 is a view showing an upper operation of an automated cargo unloading machine according to an embodiment of the present invention, FIG. 13 is a view showing a down sweep mode operation of an automated cargo unloading machine according to an embodiment of the present invention, FIG. 14 is a view showing a side sweep mode operation of an automated cargo unloading machine according to an embodiment of the present invention, FIG. 15 is a view showing a clamping mode operation of an automated cargo unloading machine according to an embodiment of the present invention, and FIG. 16 is a view showing a suction mode operation of an automated cargo unloading machine according to an embodiment of the present invention.

Referring to FIG. 10, the automated cargo unloading machine 100 may recognize a distance to the cargo, the loaded pattern of the cargo, the loaded position of the cargo, and the type of the cargo, etc. through a vision sensor or the like. In this case, the automated cargo unloading machine 100 may move toward the cargo according to the distance from the cargo. The automated cargo unloading machine 100 may sequentially unload the cargo according to a height of the loaded cargo.

Referring to FIG. 11, the automated cargo unloading machine 100 may adjust a height of a front end portion of the conveyor device 104 according to the height of the loaded cargo. The automated cargo unloading machine 100 may adjust the height of the front end portion of the conveyor device 104 based on the height of the cargo positioned at the uppermost end in the loaded cargo. That is, since the robotic arm device 102 unloads starting with the cargo positioned at the uppermost end in the loaded cargo, the height of the front end portion of the conveyor device 104 may be adjusted to a height at which the cargo positioned at the uppermost end in the loaded cargo may be safely received.

Referring to FIG. 12, the automated cargo unloading machine 100 may position the robotic arm device 102 at an upper portion of the corresponding cargo in order to unload the cargo positioned at the uppermost end in the loaded cargo. In an exemplary embodiment, when the cargo positioned at the uppermost end in the loaded cargo has a box shape and an entry space for the robotic arm device 102 is secured at an upper portion of the cargo positioned at the uppermost end, the robotic arm device 102 may operate in the down sweep mode to unload the cargo positioned at the uppermost end. In this case, the robotic arm device 102 may unload cargo positioned at an outermost in the cargo that is positioned at the uppermost end in the loaded cargo in the down sweep mode, but it is not limited thereto.

Referring to FIG. 13, it shows a state in which the robotic arm device 102 unloads the cargo positioned at the uppermost end in the loaded cargo toward the conveyor device 104 through the down sweep mode. Here, the down sweep mode may refer to an operation mode in which the unloading conveyor belt 121 is rotated in the main body frame 108 direction to sweep the target cargo downward in a state in which the unloading conveyor belt 121 of the hand unit 113 is disposed to face the target cargo at an upper portion of the target cargo (i.e., the cargo to be unloaded) (i.e., a state in which a surface of the unloading conveyor belt 121 faces an upper surface of the target cargo at the upper portion of the target cargo). In this case, depending on a number of the cargo to be unloaded through the down sweep mode or the position of the cargo, etc., the pair of unloading conveyor belts 121 may both operate in the down sweep mode, or only one of them may operate in the down sweep mode.

Referring to FIG. 14, it shows a state in which the robotic arm device 102 unloads the loaded cargo through the side sweep mode. In an exemplary embodiment, after the robotic arm device 102 unloads the cargo positioned at the outermost in the cargo that is positioned at the uppermost end in the loaded cargo in the down sweep mode, the robotic arm device 102 may unload the cargo positioned in a middle part in the side sweep mode. However, it is not limited thereto, and when the cargo positioned at the uppermost end in the loaded cargo has the box shape and the entry space for the robotic arm device 102 is secured at a side portion of the cargo positioned at the uppermost end, the robotic arm device 102 may operate in the side sweep mode to unload the cargo.

Here, the side sweep mode may refer to an operation mode in which the pair of unloading conveyor belts 121 are rotated in the main body frame 108 direction to sweep the target cargo downward in a state in which one or more target cargo is positioned between the pair of unloading conveyor belts 121, and the pair of unloading conveyor belts 121 are disposed to face the target cargo on both side portions of the target cargo (i.e., the cargo to be unloaded) (i.e., a state in which the surface of the unloading conveyor belts 121 faces a side surface of the target cargo at the side portion of the target cargo).

Specifically, the robotic arm device 102 may allow the hand unit 113 to enter a side portion space of the loaded cargo (FIG. 14A). Then, the robotic arm device 102 may be disposed so that the pair of unloading conveyor belts 121 of the hand unit 113 face the side surface of the target cargo (FIG. 14B). Then, the robotic arm device 102 may rotate the pair of unloading conveyor belts 121 in the main body frame 108 direction to unload the target cargo (FIG. 14C). In this case, the automated cargo unloading machine 100 may continue to operate in the side sweep mode while gathering the pair of robotic arm devices 102 mutually inward as the loaded cargo is unloaded.

Referring to FIG. 15, it shows a state in which the robotic arm device 102 unloads the loaded cargo through the clamping mode. In an exemplary embodiment, the automated cargo unloading machine 100 may operate the robotic arm device 102 in the clamping mode according to the type of the cargo to be unloaded. For example, when the type of the cargo to be unloaded is a cargo that may be picked up through the clamp part 125, such as the burlap sack or pouch, the automated cargo unloading machine 100 may operate the robotic arm device 102 in the clamping mode.

Specifically, when the type of the cargo is the burlap sack (FIG. 15A), the robotic arm device 102 may move the hand unit 113 toward the target cargo, and then pick up the target cargo through the clamping portion 125a of the clamp part 125 (FIG. 15B). In this case, the clamping portion 125a may be moved forward according to a distance from the target cargo. Then, the robotic arm device 102 may pull down the target cargo to unload the target cargo (FIG. 15C).

Referring to FIG. 16, it shows a state in which the robotic arm device 102 unloads the loaded cargo through the suction mode. In an exemplary embodiment, the robotic arm device 102 may unload the cargo in the suction mode according to one or more of the height of the loaded cargo and the type of the cargo. For example, when the target cargo is positioned at the lowermost end or the uppermost end and the cargo has the box shape, the robotic arm device 102 may unload the target cargo through the suction mode. FIG. 16 shows a state in which the cargo is unloaded in the suction mode when the target cargo has the box shape and is positioned at the lowermost end.

Specifically, the robotic arm device 102 may suck the target cargo through the suction pad portion 123a of the suction part 123 (FIG. 16A). In this case, the suction pad portion 123a may be moved forward according to the distance from the target cargo. Then, the robotic arm device 102 may move the target cargo to an upper portion of the conveyor device 104 in a state in which the target cargo is sucked (FIG. 16B). Then, the robotic arm device 102 may detach the target cargo from the suction pad portion 123a to unload the target cargo onto the conveyor device 104 (FIG. 16C).

According to the disclosed embodiment, the automated cargo unloading machine 100 is equipped with the pair of robotic arm devices 102 capable of multiaxial rotation and movement, and the robotic arm device 102 is equipped with the unloading conveyor belt 121, the suction part 123, and the clamp part 125, and accordingly, the automated cargo unloading machine 100 may unload the loaded cargo easily and quickly by operating in various unloading modes such as the down sweep mode, the side sweep mode, the suction mode, and the clamping mode according to the position of the loaded cargo, the loaded pattern of the cargo, and the type of the cargo, etc.

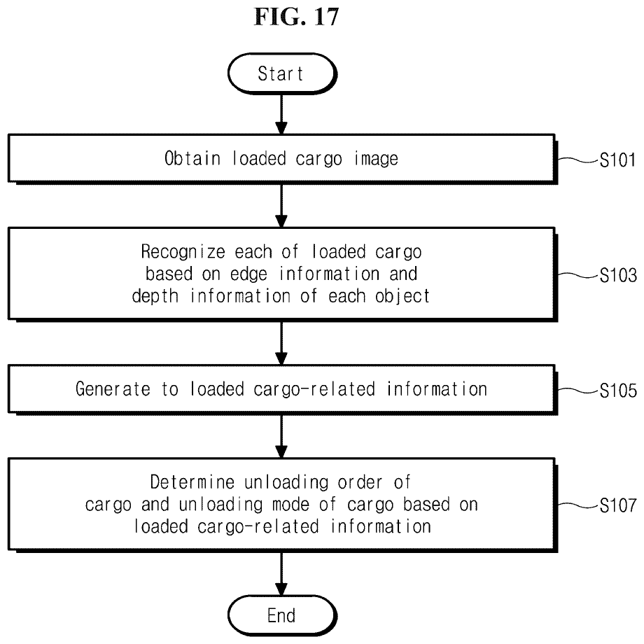

FIG. 17 is a view showing a process of determining an unloading mode in an automated cargo unloading method according to an embodiment of the present invention. Although the method is described as being divided into a plurality of steps in the flow chart shown, at least some of the steps may be performed in a different order, performed together in combination with other steps, omitted, performed by dividing into sub-steps, or performed by adding one or more steps not shown.

Referring to FIG. 17, the automated cargo unloading machine 100 may obtain an image (a loaded cargo image) photographing the cargo loaded inside the cargo box (S101). For example, the automated cargo unloading machine 100 may obtain the loaded cargo image through a 3D depth camera, a vision sensor or Lidar, and a combination thereof. Then, the automated cargo unloading machine 100 may recognize individual loaded cargo based on edge information and depth information of each object in the loaded cargo image (S103).

Here, the automated cargo unloading machine 100 photographs the inside of the cargo box from a front of the cargo box, and thus the depth information may refer to a distance between the object included in the loaded cargo image and the automated cargo unloading machine 100. The loaded cargo image may be photographed to identify the depth information. Further, the edge information of each object in the loaded cargo image may be obtained using an object segmentation model among deep learning-based artificial neural network models. The automated cargo unloading machine 100 may assign an index to each of the recognized cargo.

Then, the automated cargo unloading machine 100 may generate loaded cargo-related information including one or more of a position, a size, a type, and a loaded pattern of the cargo inside the cargo box of each of the recognized cargo (S105).

That is, the automated cargo unloading machine 100 may confirm where each of the cargo exists inside the cargo box, what the size of each of the cargo is, what the type of each of the cargo is, and what is the pattern in which the cargo inside the cargo box is loaded.

Various types of the cargo are loaded in various patterns (for example, boxes are loaded in alignment, boxes are loaded in alignment at the bottom and boxes are unaligned at the top, burlap sacks are loaded in alignment, burlap sacks are loaded in alignment at the bottom and burlap sacks are unaligned at the top, boxes are loaded at the bottom and burlap sacks are loaded at the top, etc.) inside the cargo box, and the automated cargo unloading machine 100 may analyze the loaded cargo image to generate the loaded cargo-related information.

In an exemplary embodiment, the automated cargo unloading machine 100 may use a classification model among the deep learning-based artificial neural network models when generating the loaded cargo-related information.

Then, the automated cargo unloading machine 100 may determine an unloading order of the cargo and an unloading mode of the cargo based on the loaded cargo-related information (S 107).

That is, the automated cargo unloading machine 100 may determine in what order to unload the cargo loaded inside the cargo box based on the loaded cargo-related information. Further, the automated cargo unloading machine 100 may determine through which unloading mode to unload when unloading each of the cargo. Specific details on how the automated cargo unloading machine 100 determines the unloading order of the cargo and the unloading mode of the cargo based on the loaded cargo-related information will be described later. Meanwhile, the automated cargo unloading machine 100 may recognize a caution label attached to the cargo through the loaded cargo image.

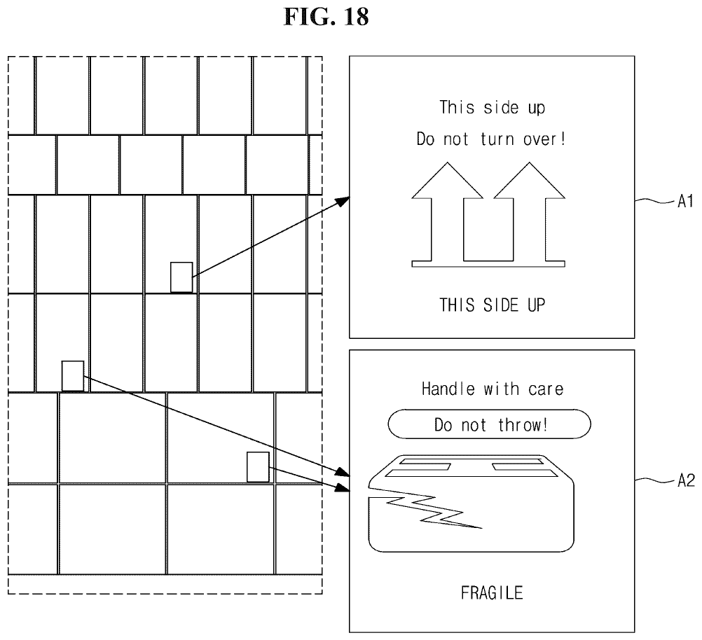

FIG. 18 is a view showing a state in which a caution label is attached to cargo in an embodiment of the present invention. As shown in FIG. 18, the cargo may have a caution label attached such as “This side up (Do not turn over)” A1 or “Handle with care (Do not throw)” A2.

Accordingly, the automated cargo unloading machine 100 may confirm whether the caution label is attached to the cargo in the loaded cargo image. When the caution label is attached to a certain cargo, the automated cargo unloading machine 100 may analyze the caution label to confirm a type of the caution (i.e., this side up, handle with care, etc.).

The automated cargo unloading machine 100 may classify each of the loaded cargo according to the type of the caution and assign a cargo caution classification index to the corresponding cargo according to the classification. For example, the automated cargo unloading machine 100 may classify the cargo without the caution label as general cargo and may classify the cargo with the caution label as the cargo with this side up or the cargo to be handled with care, etc. according to the type of the caution.

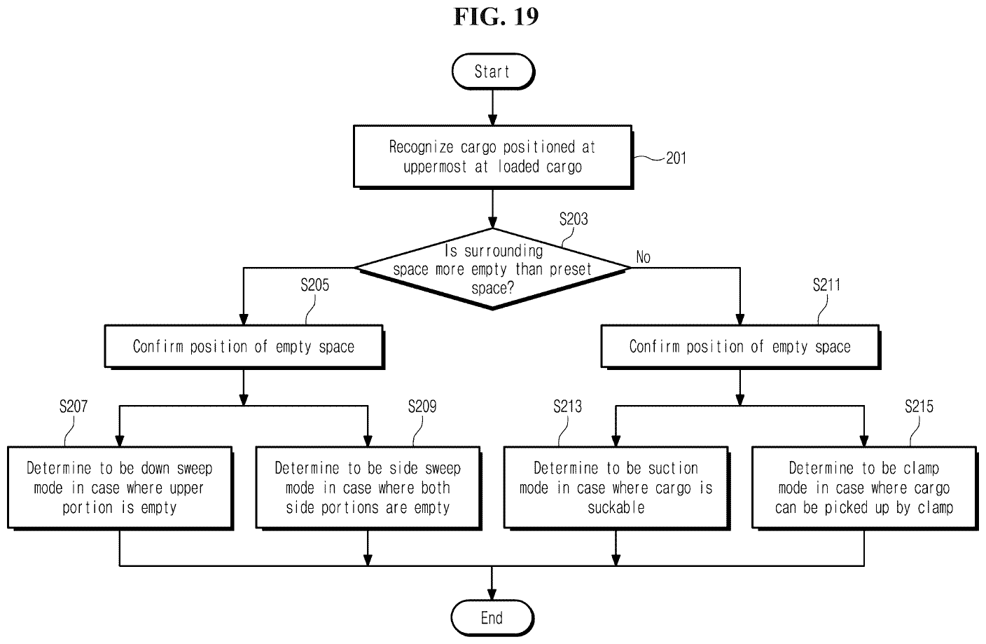

When unloading the loaded cargo, the automated cargo unloading machine 100 may confirm the cargo caution classification index of each of the cargo and unload each of the cargo in consideration of the cargo caution classification index. That is, when the cargo caution classification index of a certain cargo is the cargo with this side up, the automated cargo unloading machine 100 may unload the corresponding cargo with care so as not to turn the cargo over. When the cargo caution classification index of the certain cargo is the cargo to be handled with care, the automated cargo unloading machine 100 may unload with care so as not to apply an impact of a certain amount or more to the cargo when unloading the corresponding cargo. FIG. 19 is a flow chart showing a method of unloading cargo using an automated cargo unloading machine according to an embodiment of the present invention. Although the method is described as being divided into a plurality of steps in the flow chart shown, at least some of the steps may be performed in a different order, performed together in combination with other steps, omitted, performed by dividing into sub-steps, or performed by adding one or more steps not shown.

Referring to FIG. 19, the automated cargo unloading machine 100 recognizes the cargo positioned at an uppermost portion of the cargo loaded inside the cargo box (S201). Then, the automated cargo unloading machine 100 confirms whether a surrounding space of the cargo positioned at the uppermost portion is more empty than a preset space (S203). Here, the preset space may refer to a space in which the hand unit 113 of the robotic arm device 102 may enter.

As a result of confirming in step S203, when the surrounding space of the cargo positioned at the uppermost portion is more empty than the preset space, the automated cargo unloading machine 100 confirms a position of the empty space based on the cargo positioned at the uppermost portion (S205).

As a result of confirming in step S205, when an upper portion is empty with the preset space based on the cargo positioned at the uppermost portion, the automated cargo unloading machine 100 may determine the unloading mode of the cargo positioned at the uppermost portion to be the down sweep mode (S207).

As a result of confirming in step S205, when both side portions are empty with the preset space based on the cargo positioned at the uppermost portion, the automated cargo unloading machine 100 may determine the unloading mode of the cargo positioned at the uppermost portion to be the side sweep mode (S209).

Meanwhile, as a result of confirming in step S203, when the surrounding space of the cargo positioned at the uppermost portion is not more empty than the preset space, the automated cargo unloading machine 100 may confirm the type of the cargo positioned at the uppermost portion (S211).

As a result of confirming in step S211, when the type of the cargo positioned at the uppermost portion is a suckable cargo (for example, the type of the cargo is a box or a pouch, etc.), the automated cargo unloading machine 100 may determine the unloading mode of the cargo positioned at the uppermost portion to be the suction mode (S213).

As a result of confirming in step S211, when the type of the cargo positioned at the uppermost portion is the cargo that may be picked up with a clamp (for example, the type of the cargo is a burlap sack or a pouch, etc.), the automated cargo unloading machine 100 may determine the unloading mode of the cargo positioned at the uppermost portion to be the clamping mode (S215).

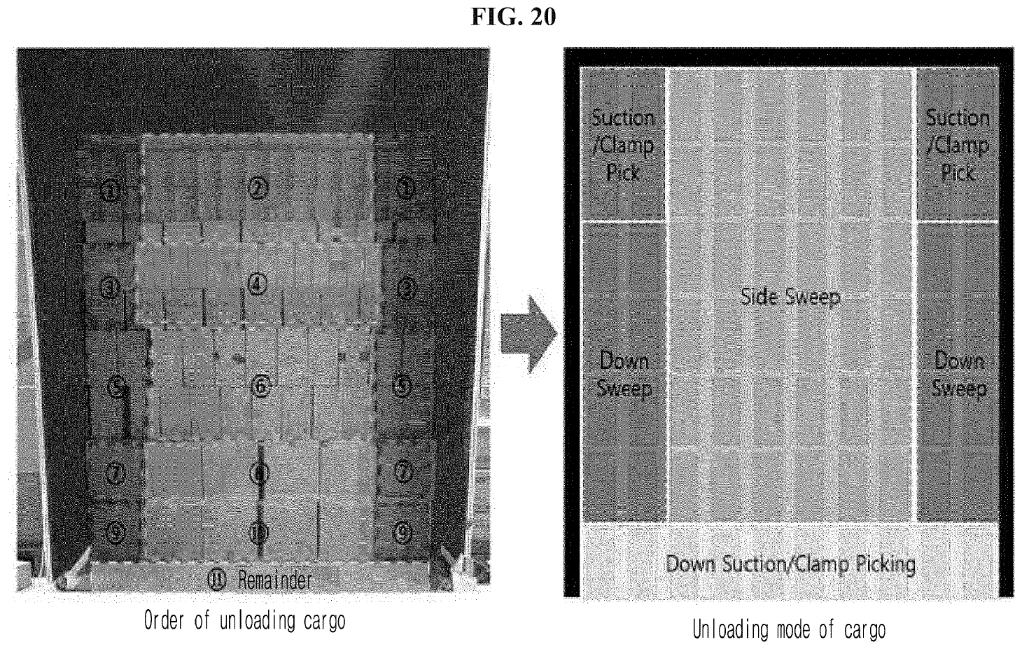

FIG. 20 is a view showing a state in which an unloading order of cargo and an unloading mode of the cargo are determined according to loaded cargo-related information according to an embodiment of the present invention.

Referring to FIG. 20, after the cargo positioned at both sides of an uppermost layer of the cargo loaded inside the cargo box is unloaded in the suction mode or the clamping mode, the cargo positioned therebetween is unloaded in the side sweep mode. Then, after the cargo positioned at both sides of a lower layer thereof is unloaded in the down sweep mode, the cargo positioned therebetween is unloaded in the side sweep mode. In this way, the cargo may be unloaded to a layer positioned above the lowermost layer, and the cargo at the lowermost layer may be unloaded in the suction mode or the clamping mode.

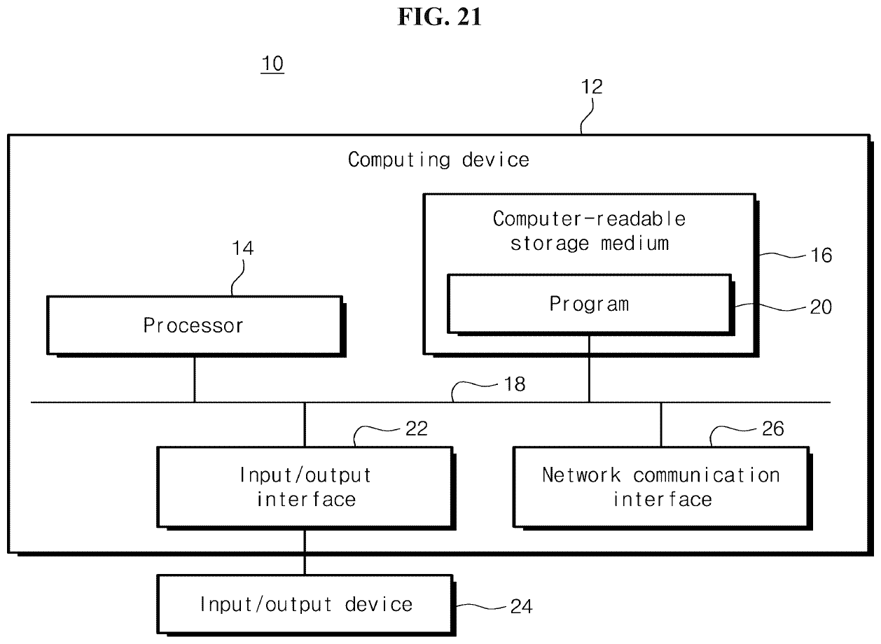

FIG. 21 is a block diagram showing a computing environment 10 including a computing device suitable for using in exemplary embodiments. In the shown embodiment, each component may have different functions and capabilities other than those described below, and may include additional components other than those described below.

The shown computing environment 10 includes a computing device 12. In an embodiment, the computing device 12 may be the automated cargo unloading machine 100. The computing device 12 may be a device for performing the automated cargo unloading method.

The computing device 12 includes at least one of a processor 14, a computer-readable storage medium 16, and a communication bus 18. The processor 14 may cause the computing device 12 to operate according to the above-mentioned exemplary embodiments. For example, the processor 14 may execute one or more programs stored in the computer-readable storage medium 16. The one or more programs may include one or more computer-executable commands, and when the computer-executable commands are executed by the processor 14, the processor 14 may be configured to cause the computing device 12 to perform operations according to the exemplary embodiments.

The computer-readable storage medium 16 is configured to store the computer-executable commands or program code, program data, and/or other suitable forms of information. A program 20 stored in the computer-readable storage medium 16 includes a set of commands executable by the processor 14. In an embodiment, the computer-readable storage medium 16 may be a memory (e.g., volatile memory such as random access memory, non-volatile memory, or a suitable combination thereof), one or more magnetic disk storage devices, optical disk storage devices, flash memory devices, any other form of storage medium capable of being accessed by the computing device 12 and storing desired information, or a suitable combination thereof.

The communication bus 18 includes the processor 14 and the computer-readable storage medium 16 to interconnect various other components of the computing device 12.

The computing device 12 may also include one or more input/output interfaces 22 and one or more network communication interfaces 26 that provide interfaces for one or more input/output devices 24. The input/output interface 22 and the network communication interface 26 are connected to the communication bus 18. The input/output device 24 may be connected to other components of the computing device 12 through the input/output interface 22. An exemplary input/output device 24 may include input devices such as a pointing device (such as a mouse or trackpad), a keyboard, a touch input device (such as a touchpad or a touchscreen), a voice or sound input device, various types of sensor devices and/or photographing devices, and/or output devices such as a display device, a printer, a speaker, and/or a network card. The exemplary input/output device 24 may be included inside the computing device 12 as a component constituting the computing device 12 or may be connected to the computing device 12 as a separate device distinct from the computing device 12.

The above detailed description is illustrative of the present invention. In addition, the above-mentioned description describes preferred embodiments of the present invention, and the present invention may be used in various other combinations, modifications, and environments. That is, modifications or amendments are possible within the scope of the spirit of the invention disclosed herein, the scope equivalent to the described disclosure, and/or the scope of technology or knowledge in the related art. The described embodiments are intended to describe the best possible state for implementing the technical idea of the present invention, and various modifications required for specific application fields and uses of the present invention are also possible. Therefore, the detailed description of the invention is not intended to limit the present invention to the disclosed embodiments. In addition, the appended claims should be construed to include other embodiments.

What is claimed is:

1. An automated cargo unloading method which is performed by an automated cargo unloading machine including one or more processors and a memory for storing one or more programs executed by the one or more processors, comprising:
obtaining a loaded cargo image photographed inside a cargo box in which cargo is loaded;
recognizing each of the loaded cargo in the loaded cargo image based on edge information and depth information of each object;
generating loaded cargo-related information including one or more of a position, a size, a type, and a loaded pattern of the cargo inside the cargo box of each of the recognized cargo; and
determining one or more of an unloading order of the cargo inside the cargo box and an unloading mode of the cargo based on the loaded cargo-related information.

2. The automated cargo unloading method of claim 1,
the method further comprising:
confirming whether a caution label is attached to the cargo through the loaded cargo image; and
confirming a type of cautions by analyzing the caution label when the caution label is attached.

3. The automated cargo unloading method of claim 2,
the method further comprising:
assigning a cargo caution classification index to the corresponding cargo according to the type of the cautions; and
unloading the corresponding cargo from the cargo box based on the cargo caution classification index.

4. The automated cargo unloading method of claim 1,
wherein the automated cargo unloading machine is equipped with a pair of robotic arm devices including an arm unit provided to enable multiaxial rotation and forward and backward movement and a hand unit connected to the arm unit and contacting the cargo to unload the cargo, respectively, and
each of the hand units includes an unloading conveyor belt provided to sweep down the cargo inside the cargo box.

5. The automated cargo unloading method of claim 4,
wherein the determining of the one or more of the unloading order of the cargo and the unloading mode of the cargo includes
confirming whether a surrounding space of the cargo positioned at an uppermost portion of the cargo box is more empty than a preset space, and
determining the unloading mode of the cargo positioned at the uppermost portion to be a down sweep mode in a case where an upper portion of the cargo is more empty than the preset space based on the cargo positioned at the uppermost portion.

6. The automated cargo unloading method of claim 5,
wherein the down sweep mode rotates the unloading conveyor belt toward the automated cargo unloading machine to sweep the cargo downward in a state in which the unloading conveyor belt is disposed to face the cargo at the upper portion of the cargo.

7. The automated cargo unloading method of claim 4,
wherein the determining of the one or more of the unloading order of the cargo and the unloading mode of the cargo includes
confirming whether a surrounding space of the cargo positioned at an uppermost portion of the cargo box is more empty than a preset space, and
determining the unloading mode of the cargo positioned at the uppermost portion to be a side sweep mode in a case where both side portions are more empty than the preset space based on the cargo positioned at the uppermost portion.

8. The automated cargo unloading method of claim 7,
wherein the side sweep mode rotates a pair of the unloading conveyor belts toward the automated cargo unloading machine to sweep the cargo downward in a state in which the loaded cargo is positioned between the pair of unloading conveyor belts and the pair of unloading conveyor belts are disposed to face the cargo at both side portions of the cargo.

9. The automated cargo unloading method of claim 4,
wherein each of the hand unit further includes a suction part for sucking the cargo inside the cargo box, and
the determining of the one or more of the unloading order of the cargo and the unloading mode of the cargo includes
confirming whether a surrounding space of the cargo positioned at an uppermost portion of the cargo box is more empty than a preset space, and
determining the unloading mode of the cargo to be a suction mode according to the type of the cargo positioned at the uppermost portion in a case where the surrounding space is not more empty than the preset space.

10. The automated cargo unloading method of claim 4,
wherein each of the hand unit further includes a clamp part capable of picking up the cargo inside the cargo box, and
the determining of the one or more of the unloading order of the cargo and the unloading mode of the cargo includes
confirming whether a surrounding space of the cargo positioned at an uppermost portion of the cargo box is more empty than a preset space, and
determining the unloading mode of the cargo to be a clamping mode according to the type of the cargo positioned at the uppermost portion in a case where the surrounding space is not more empty than the preset space.

11. A computing device comprising:
one or more processors;
a memory; and
one or more programs,
wherein the one or more programs are stored in the memory and configured to be executed by the one or more processors, and
the one or more programs include
a command for obtaining a loaded cargo image photographed inside a cargo box in which the cargo is loaded,
a command for recognizing each of the loaded cargo in the loaded cargo image based on edge information and depth information of each object,
a command for generating loaded cargo-related information including one or more of a position, a size, a type, and a loaded pattern of the cargo inside the cargo box of each of the recognized cargo, and
a command for determining the one or more of an unloading order of the cargo inside the cargo box and an unloading mode of the cargo based on the loaded cargo-related information.
